(19) United States
(12) Patent Application Publication
(10) Pub. No.: US 2020/0171628 A1
(43) Pub. Date: Jun. 4, 2020

(54) BACKFLOW VALVE HANDLE ENGAGEMENT SYSTEM AND METHOD OF USE

(71) Applicant: Richard Weldon Long, Holliday, TX (US)

(72) Inventor: Richard Weldon Long, Holliday, TX (US)

(21) Appl. No.: 16/699,588

(22) Filed: Nov. 30, 2019

Related U.S. Application Data
(60) Provisional application No. 62/774,044, filed on Nov. 30, 2018.
(60) Provisional application No. 62/939,983, filed on Nov. 25, 2019.

(51) Int. Cl. B25B 13/58; F16K 31/60

(52) U.S. Cl. CPC B25B 13/58; B25B 13/48; F16K 31/602

(57) ABSTRACT

A tool for engaging with a backflow valve handle includes a body forming a channel extending from a first side to a second side, the channel extending upward from a bottom surface of the body; and an adapter extending from a top surface of the body, the adapter to receive a hand tool; the channel is to secure over the backflow valve handle; and the adapter is to receive torque from a user to loosen the backflow valve handle.

### BACKGROUND

### 1. Field of the Invention

The present invention relates generally to backflow prevention devices, and more specifically, to a tool for engaging with a handle of a backflow valve system to protect the handle and apply consistent pressure to the handle in order to prevent breakage.

### 2. Description of Related Art

Backflow prevention devices are well known in the art and are conventionally used to protect potable water supplies from contamination or pollution due to backflow. For example, FIG. 1 depicts a conventional backflow prevention system 101 having a valve 103 with a handle 105 and a backflow apparatus 107 there engaged. During use, the valve 103 is opened and closed via handle 105 for checking that the system is working properly.

One of the problems commonly associated with system 101 is damage to handle 105. For example, it is common for the handle 105 to become rusted and weak, thereby being likely to break when pressure is applied.

Accordingly, although great strides have been made in the area of backflow prevention devices, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of a conventional backflow prevention system;

FIGS. 2A and 2B are front views of a backflow prevention system with a tool for engagement with the handle in accordance with a preferred embodiment of the present application;

FIG. 3 is a side view of the tool of FIG. 2;

FIG. 4 is a top view of the tool of FIG. 2; and

FIG. 5 is a flowchart of a method of use of the system of FIG. 2.

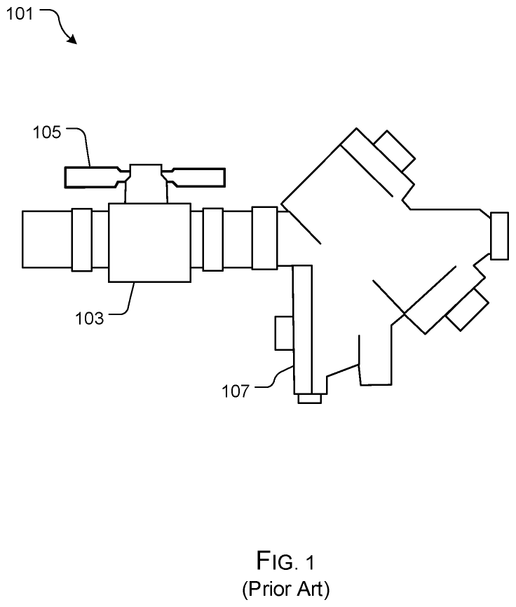

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional backflow prevention systems. Specifically, the present invention provides for a tool to engage with a handle and protect the handle during the application of torque. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

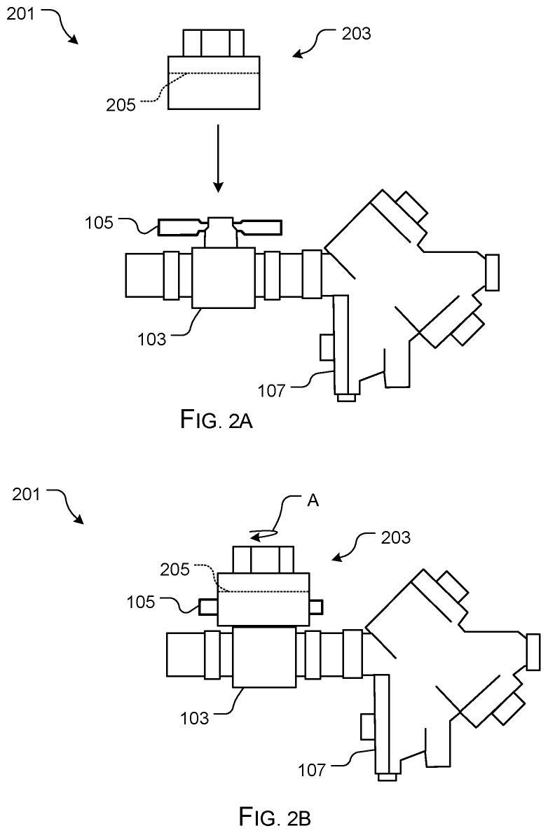

Referring now to the drawings wherein like reference characters identify corresponding or similar elements throughout the several views, FIGS. 2A and 2B depict front views of a backflow prevention system 201 in accordance with a preferred embodiment of the present application. It will be appreciated that system 201 overcomes one or more of the above-listed problems commonly associated with conventional backflow prevention systems.

In the contemplated embodiment, system 201 includes a tool 203 having a channel 205, wherein the tool 203 is configured to engage with handle 105. The channel 205 extends from a first side to a second side of the tool 203 and is configured to secure over the handle, wherein the walls of the channel provide for consistent pressure when turning the handle, thereby preventing the handle from breaking. The system is configured to utilize a hand tool, such as either a ⅜″ drive ratchet or a 1″ wrench or socket to apply torque to the tool and thereby torque (arrow A) to the handle.

It should be appreciated that one of the unique features believed characteristic of the present application is the tool 203. The tool 203 provides for an easy and efficient means to protect the handle 105 when pressure is applied.

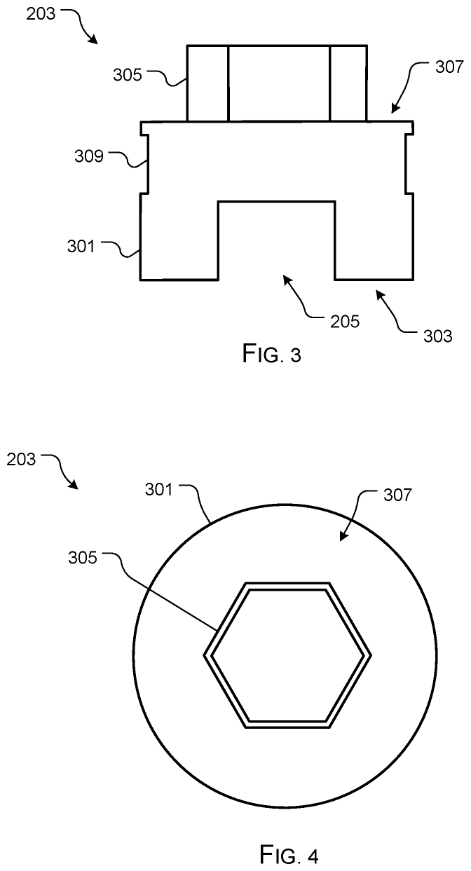

In FIG. 3, a side view depicts tool 203. Tool 203 includes a body 301 with the channel 205 disposed therein. The channel 205 can vary in widths, however, it extends from a first side to a second side, and extends upwards into the body 301 from a bottom surface 303. Tool 203 further includes an adapter 305 extending upward from a top surface 307, wherein the adapter is configured to receive the hand tool, as described above. In some embodiments, the body 301 further includes one or more notches 309 extending into the body.

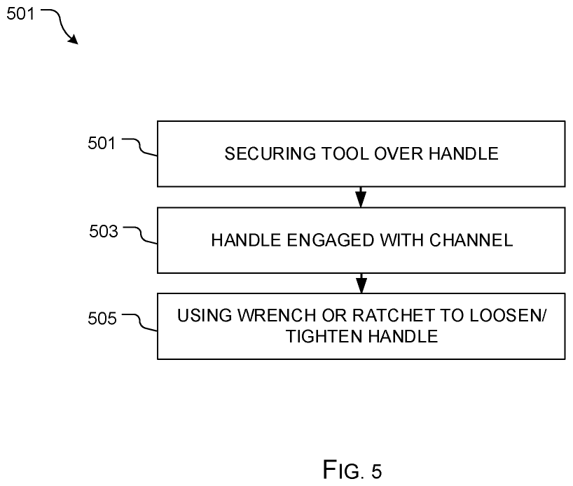

As shown in FIG. 4, in some embodiments, the adapter 305 is hexagonal in shape, thereby being configured to receive a wrench or the like. However, it should be appreciated that alternative embodiments could be configured in different shapes and sizes as needed.

In FIG. 5, a flowchart 501 depicts the method of use of system 201. During use, the tool is secured over the handle, wherein the user can proceed to engage with the tool with a hand tool, such as a wrench or ratchet, as shown with boxes 501, 503. The user can then use the hand tool to loosen or tighten the handle, as shown with box 505.

It should be appreciated that the tool can vary in materials, and can be adapted for use in various valve and backflow prevention systems.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A tool for engaging with a backflow valve handle, the tool comprising:
a body forming a channel extending from a first side to a second side, the channel extending upward from a bottom surface of the body; and
an adapter extending from a top surface of the body, the adapter configured to receive a hand tool;
wherein the channel is configured to secure over the backflow valve handle; and
wherein the adapter is configured to receive torque from a user to loosen the backflow valve handle.

2. A backflow valve opening system, comprising:
a backflow valve having a handle extending therefrom;
a tool configured to secure over the handle, the tool having:
a body forming a channel extending from a first side to a second side, the channel extending upward from a bottom surface of the body;
an adapter extending from a top surface of the body, the adapter configured to receive a hand tool;
wherein the channel is configured to secure over the backflow valve handle; and
wherein the adapter is configured to receive torque from a user to loosen the backflow valve handle.

3. A method of opening a backflow valve, the method comprising:
providing a tool having a body forming a channel extending from a first side to a second side, the channel extending upward from a bottom surface of the body, and the tool further having an adapter extending from a top surface of the body, the adapter configured to receive a hand tool;
securing the tool over a handle of the backflow valve such that the handle is positioned within the channel;
engaging a hand tool with the adapter; and
providing torque to the tool via the hand tool to loosen the handle.
